(19) United States
(12) Patent Application Publication
(10) Pub. No.: US 2007/0039932 A1
(43) Pub. Date: Feb. 22, 2007

(54) Device for separative machining of components made from brittle material with stress-free component mounting

(76) Inventors: Michael Haase, Grunenplan (DE); Oliver Haupt, Hannover (DE)

Correspondence Address: SHLESINGER, ARKWRIGHT & GARVEY LLP, Suite 600, 1420 King Street, Alexandria, VA, 22314, US

(21) Appl. No.: 11/588,286

(22) Filed: Oct. 27, 2006

Related U.S. Application Data
(63) Continuation of application No. PCT/EP05/03416, filed on Apr. 1, 2005.

(30) Foreign Application Priority Data
Apr. 27, 2004 (DE) 10 2004 020 737.2

(51) Int. Cl. B23K 26/38

(52) U.S. Cl. 219/121.67

(57) ABSTRACT

Device for separative machining of a component made from brittle material by generation of a thermally induced stress fracture on the component in a separation zone includes a laser device for directing a laser beam onto the component for separative machining. The component partially transmits the laser beam, in use, at least twice and with partial absorption of the laser beam, and one of simultaneously and serially along the separation zone, and at one of the same point(s). Mounting device is provided including a bearing surface upon which the component made from brittle material for machining can be mounted, in use, to avoid externally induced mechanical stresses on the component. Bearing surface includes a material highly transmissive for the laser beam. The bearing surface may include a material that is reflective for the laser beam instead of or in addition to the material highly transmissive for the laser beam.

### CROSS-REFERENCE TO RELATED APPLICATIONS

This application is a continuation of application no. PCT/EP2005/003416, filed Apr. 1, 2005, which claims the priority of German application no. 10 2004 020 737.2, filed Apr. 27, 2004, and each of which is incorporated herein by reference.

### FIELD OF THE INVENTION

The invention relates to a device for the separative machining of components made from brittle material. More particularly, the invention relates to a device for the separative machining of components made from brittle material, such as e.g. glass, ceramics, glass ceramics etc., by generation of a thermally induced stress fracture on the component in the separation zone, the inventive device including a laser device for directing a laser beam onto the component for machining, in such a way that the component partially transmits the laser beam at least twice with partial absorption simultaneously or serially along the separation zone substantially at the same point or at points at minimal distances relative to each other

### BACKGROUND OF THE INVENTION

Devices for the separative machining of components made from brittle material are known in the art, e.g. for the separating of laminated glass, and they provide that a small carbide wheel is guided, respectively, across the top and bottom sides of the component. The small, carbide wheels generate mechanical stresses inside the component for machining that result in the separation of the component in the desired fashion. If complex contours are to be achieved with the separating action of the components, the component intended for separative machining is moved across a further axis on a felt table. A disadvantage of this known apparatus is the fact that the setup is quite complex and the results of the separative component machining are quite imprecise.

WO 02/48059 describes an apparatus of the this kind for the separative machining of components made from brittle material, such as e.g. glass, ceramics, glass ceramics etc., by generating a thermally induced stress fracture on the component in a separation zone. The known device includes a laser device for directing a laser beam onto the component for machining, in particular in such a way that the component partially transmits the laser beam with partial absorption at least twice either simultaneously or serially along the separation zone substantially at the same point or at points arranged at a minimal distance relative to each other. The known apparatus allows for precise separating action at high speed of the components for machining.

A similar device is also known from DE 102 06 920 Al. =cl OBJECTS AND SUMMARY OF THE INVENTION

An object of the invention is to overcome the drawbacks of the prior art devices.

Another object of the invention includes providing a device for the separative machining of components made from brittle material, such as e.g. glass, ceramics, glass ceramics etc., by generation of a thermally induced stress fracture on the component in the separation zone, the inventive device including a laser device for directing a laser beam onto the component for machining, in such a way that the component partially transmits the laser beam at least twice with partial absorption simultaneously or serially along the separation zone substantially at the same point or at points at minimal distances relative to each other, and that further improves precision in the area of separative machining of components made from brittle material.

This object is achieved by the inventive device for separative machining of a component made from brittle material by generation of a thermally induced stress fracture on the component in a separation zone includes a laser device for directing a laser beam onto the component for separative machining. The component partially transmits the laser beam, in use, at least twice and with partial absorption of the laser beam, and one of simultaneously and serially along the separation zone, and at one of the same point(s). A mounting device is provided including a bearing surface upon which the component made from brittle material for machining can be mounted, in use, to avoid externally induced mechanical stresses on the component. The bearing surface includes a material highly transmissive for the laser beam. The bearing surface may include a material that is reflective for the laser beam instead of or in addition to the material highly transmissive for the laser beam.

The teaching according to the invention is based on the knowledge that an especially high level of precision can be achieved during the separative machining of components made from brittle material, if the mechanical stresses that lead to the separative process are exclusively or almost exclusively thermally induced mechanical stresses by the laser, which means that externally induced mechanical stresses are not present or only are only present to such an extent that they do not impact the machining result. Externally induced mechanical stresses according to the invention are defined as mechanical stresses which are not thermally induced by the laser device but which are generated in a different way, for example, by a mechanical load applied upon the component.

Correspondingly, the underlying idea of the teaching according to the invention is to provide a bearing surface on which the component for machining can be mounted in order to reduce or avoid externally induced mechanical stresses. To make possible a multiple transmission of the laser beam through the component, and thereby sufficient absorption of the laser beam possible, the bearing surface is comprised at least in part of a material that is highly transmissive for the laser beam. In this way, the laser beam is able to traverse the bearing surface and impinge, for example, on a reflector arranged on the side of the bearing surface that is facing away from the component for machining. The reflector can then reflect the laser beam back to the separation zone causing the component to partially transmit the laser beam with partial absorption at least twice, thus producing thermally induced mechanical stresses in the component for machining that will result in a separating action of the component.

With the bearing surface envisioned according to the invention it is possible to avoid externally induced mechanical stresses or reduce them to a level that no longer influences the precision of the machining result. In this way, the apparatus according to the invention is instrumental in providing a substantial improvement of the precision with regard to the separative machining of components made from brittle material. At the same time, the basic advantages inherent in the use of a laser beam for separative machining are preserved.

According to the invention the bearing surface can be comprised entirely of a material that is highly transmissive for a laser beam. But according to the invention it is also possible for the bearing surface to include only partially, for example a line-shaped or two-dimensionally shaped region, of a material that is highly transmissive for a laser beam.

According to the invention a highly transmissive material is defined as a material that has a transmissivity (level of transmittance) that is, at the wavelength of the employed laser beam relative to the respective same material thickness, higher than the transmissivity (level of transmittance) of the material of the component for machining. Correspondingly, the result is a different absorption behavior with regard to the component for machining, on the one hand, and the bearing surface, on the other hand, in particular in that the laser beam is absorbed to a greater, preferably considerably greater, degree by the material of the component for machining than by the material comprising the bearing surface, whereby it is possible to separate the component for machining by way of thermally induced stresses without damaging the highly transmissive material that serves as the bearing surface. Relative to the extinction coefficient k, which is a measure of the weakening of electromagnetic radiation in a material irrespective of thickness, a highly transmissive material is defined as a material with an extinction coefficient that is smaller at the employed wavelength than the extinction coefficient of the material of the component for machining. In particular, according to the invention a highly transmissive material is defined as a material with an extinction coefficient that has a value of k≦approximately 17 m⁻¹ in the wavelength range of approximately 1,000 nm.

If, for example, the device according to the invention is to be used to separate a component made from soda-lime glass, the selected material for the bearing area is a material of a transmissivity that is higher for the employed wavelength of the laser beam than the transmissivity of the soda-lime glass and/or the extinction coefficient k of which is smaller for the employed wavelength of the laser beam than the extinction coefficient of soda-lime glass.

To achieve a mounting that is free of externally induced mechanical stresses, or that has few externally induced mechanical stresses, the invention provides that the contour of the bearing surface is adjusted to the contour of the component for machining. If the component for machining is, for example and in particular, a flat glass pane, the bearing surface is substantially configured as flat allowing the flat glass pane to rest evenly on the bearing surface, ideally free of any externally induced mechanical stresses. If, on the other hand, the component for machining is configured as curved, the bearing surface can according to the invention be configured substantially as a complement to the contour of the component.

Another solution for the underlying object of the invention provides that the bearing surface includes, at least in part, a material that reflects the laser beam. In this way, the laser beam that traversed the component for machining is reflected back from the bearing surface to the separation zone. The same advantages result with regard to component mounting free of externally induced mechanical stresses or low in externally induced mechanical stresses as with regard to the teachings set forth herein.

An improvement of the teaching according to the invention provides that the mounting device be provided with a counter- bearing surface, and the space between the bearing surface and the counter-bearing surface is able to receive a multitude of components for machining piled one on top of the other and/or serially one arranged next to the other; and the counter-bearing surface hereby includes at least in part of a material that is highly transmissive for a laser beam. With this embodiment a particularly secure mounting of the component and/or components for machining is achieved. Due to the fact that the counter- bearing surface is comprised at least in part of a material that is highly transmissive for a laser beam, the laser beam is able to traverse the counter-bearing surface.

If the component for machining is configured as substantially flat on at least one side, an advantageous improvement of the teaching according to the invention provides that the bearing surface and/or counter-bearing surface is configured as substantially flat for the mounting of components having at least one substantially flat side. The result is a mounting action of components that is especially stress-free with regard to components that are configured as flat on at least one side.

Another advantageous improvement provides that the material that includes at least in part the bearing surface and/or the counter-bearing surface has a lower thermal expansion coefficient and/or higher transmissivity for a laser beam than the material of the component for machining. For example and in particular, the material can have a thermal expansion coefficient of ≦9×10⁻⁶ K.

To achieve at least a double transmission with partial absorption of the laser beam through the component for machining that is simple and in particular cost-efficient an advantageous improvement of the teaching according to the invention provides the use of a reflecting device including at least one first reflector arranged on the side of the component that is directed away from the laser and which reflects the laser beam that is transmitted through the component onto the separation zone.

In order to forego use of a separate reflector in the context of the previously referred to embodiment, to thus reduce the apparatus-specific complexity of the device according to the invention, an advantageous improvement of the teaching according to the invention provides that the reflecting device includes at least in part an area of the bearing surface that reflects the laser beam.

To achieve an especially simple and thereby cost-effective setup with the embodiment referred to above an advantageous improvement provides that the bearing surface is at least in part provided with a laser-reflecting coating.

This embodiment therefore provides that the laser beam is reflected by the surface proper of the bearing surface.

Another advantageous improvement of the teaching according to the invention provides a mounting element that is configured as a layer-type element having at least one mounting layer which has the bearing surface arranged on one of its sides, in particular the side that is directed toward the component, and the bearing surface includes a layer that is highly transmissive for a laser beam, and having a reflecting layer that includes a material that reflects the laser beam. With this embodiment the reflecting layer may be provided beneath the surface of the mounting element and therefore remote from the bearing surface. This has the advantage that the reflecting layer does not make contact with the components to be machined, whereby any damage and/or wear and tear of the reflecting layer are avoided. The mounting layer may, for example, be made from a material of much higher abrasion resistance than the material of the reflecting layer.

A further improvement of the embodiment including a reflecting device or element provides that the reflecting device has at least a second reflector that is arranged on the side of the component which is directed toward the laser device; and whereby the first reflector reflects the laser beam through the separation zone onto the second reflector, and whereby the second reflector reflects the laser beam that is reflected by the first reflector onto the separation zone. In this embodiment the laser beam that is generated by the laser device is reflected multiple times which is why it is, correspondingly, partially absorbed multiple times by the component along the separation zone. In this way it is possible to achieve a quick and intensive heating up of the component at the respective irradiated point in the separation zone.

Depending on the respective requirements it is possible to configure the reflecting device as flat or as curved, as this is envisioned in the improvements of the teaching according to the invention.

An improvement of the embodiment involving the second reflector provides that the second reflector reflects the laser beam back to the first reflector. In this embodiment the beam is reflected back and forth multiple times between the first reflector and the second reflector allowing for the possibility of using a simple and cost-effective device for the multiple reflection action of the laser beam through the component and thereby multiple traversings of the component accompanied by the associated correspondingly intensive heating-up of the component.

According to the invention it is basically sufficient if the incoming laser beam and the laser beam that is reflected by the first reflector impinges at points along the separation zone of the component that are at a distance relative to each other and/or if the laser beam that is reflected from the first reflector to the second reflector and the laser beam that is reflected back from the second reflector to the first reflector impinges on the component at points in the separation zone that are at a distance relative to each other, provided the heating- up of the component that is effected during this process along the separation zone is continual and sufficient to cause a thermally induced stress fracture. A particularly advantageous improvement of the teaching according to the invention, however, provides that the incoming laser beam and the laser beam that is reflected by the first reflector and/or the laser beam that is reflected by the first reflector onto the second reflector and the laser beam that is reflected back from the second reflector to the first reflector impinges substantially at the same point in the separation zone of the component. This creates a particularly fast and intensive heating-up of the component at the point where the incoming and reflected laser beams jointly impinge upon the component.

The first and/or, if need be, the second reflector are suitably arranged in the direction of the beam at a distance relative to the component for machining. This prevents that heat from the component is lost in an undesired manner by the reflector and/or by the reflectors.

Another configuration of the basic idea of the teaching according to the invention provides that at least two laser devices are provided that, respectively, direct a laser beam along the separation zone substantially onto the same point or onto points on the component that are at a minimal distance relative to each other. Correspondingly, it is ensured that the laser beam of the component traverses the same point or the same points that are at a minimal distance relative to each other along the separation zone substantially at least twice without any need of having to reflect the laser beam.

In the previously referred to embodiment the laser devices are suitably arranged on opposite sides of the component so that they direct the laser beam from opposite sides of the component onto the component.

Another improvement of the teaching according to the invention provides a beam splitting device that divides the laser beam emitted by the laser device into at least two partial beams as well as beam directing device that directs the partial beams along the separation zone substantially to the same point on the component or to points on the component that are at a minimal distance relative to each other. A second laser device is not necessary for this arrangement. The beam directing device suitably directs the partial beams from opposite sides onto the component.

The wavelength of the laser beam is suitably in a range of between approximately 500 to approximately 5,000 nm, in particular approximately 1,000 nm. Even though glass, in particular, primarily transmits a laser beam of this wavelength, the fact that the laser beam is transmitted through the component at least twice with partial absorption ensures that a sufficient heating-up of the material of the component is still possible. An Nd: YAG laser or a Yb: YAG laser of a wavelength of 1,000 nm is especially preferred, respectively, for the machining of soda-lime glass.

Other advantageous improvements of the teaching according to the invention envision that the component is a flat glass pane and/or that, for the purpose of simultaneous machining of at least two components, the components are arranged in series, one after the other, in the direction of the beam. This allows for the simultaneous machining of multiple components thereby accelerating the machining process and rendering it especially cost-effective.

An improvement of the embodiment referred to previously provides that the flat glass panes are arranged adjacently resting against each other.

Corresponding to the respective requirements, it is also possible according to the invention that at least one spacer device is arranged between the at least two components that includes at least sectionally a material that is highly transmissive for laser beams. This allows, on the one hand, for a mounting of the components at a distance relative to each other and ensures, on the other hand, that the laser beam traverses the spacer device avoiding any undesired excessive absorption.

An advantageous improvement of the above referred to embodiment provides that the spacer device is coated with a friction-reducing element or that the friction-reducing element is arranged between the component for machining and the bearing surface. This arrangement avoids the generation of any undesired externally induced mechanical stresses due to friction between the components for machining and the spacer device. Suitable for use as friction-reducing element is, for example, a powdery substance, water or air. Correspondingly, air that remains between a component for machining and an assigned spacer device is able to sufficiently reduce friction.

Another improvement provides that the friction-reducing element is arranged outside of the path of the laser beam. This reduces any influencing of the laser beam by the spacer device, in particular absorption.

The device according to the invention is suitable for the separative machining of any components made from a brittle material. The device according to the invention is particularly well suited for the separative machining of components made from borosilicate glass or soda-lime glass.

Another improvement of the teaching according to the invention provides a device that allows for the possibility of moving the component and the laser device relative to each other, in particular during the machining process. By moving the component and the radiation source relative to each other it is possible to achieve with this embodiment a heating-up along the separation zone by a beam having an substantially point- shaped beam spot and in that the component and radiation source are moved relative to each other corresponding to the course of the separation zone.

An improvement of the embodiment that provides for the laser beam to be reflected back and forth between the first reflector and the second reflector provides that the second reflector is configured in such a way that it either transmits or reflects the laser beam depending on its polarization, that the laser emits the incoming beam from the side that is directed away from the first reflector; and the polarization of the laser beam is selected in such a manner that the second reflector transmits the incoming beam and that the first reflector influences the polarization of the laser beam in such a way that the second reflector reflects the laser beam upon the subsequent impingement of the laser beam. With this embodiment, using a simple setup of the device, it is possible to achieve multiple reflections of the laser beam onto the same point on the component.

Another improvement of the teaching according to the invention provides for a device to shape the beam of the laser device. With this it is possible to achieve, corresponding to whatever the respective requirements are, for example, a line-shaped beam or a beam spot having any other geometry.

Another advantageous improvement of the teaching according to the invention provides for a measuring device in order to measure the temperature and/or the stress distribution in the component for machining and/or the components for machining as well as a control device and/or regulation device that control and/or regulate the output and/or intensity and/or the focus and/or beam profile of the laser beam dependent on at least one output signal of the measuring device. This embodiment allows for special precision during the separative machining process of the components because temperature distribution and/or stress distribution inside the component for machining is/are measured and the laser beam can be controlled or regulated, in particularly with regard to its intensity and/or its focus and/or its beam profile, in correlation with the measured temperature distribution and/or stress distribution.

Subsequently, the invention will be illustrated in more detail using the enclosed drawing that depicts embodiments of a device according to the invention. In this context all characteristics, either taken by themselves or in combination, that are described or represented in the drawing constitute the subject of the invention, irrespective of the way they are summarized in the patent claims or referenced and irrespective of their wording and/or representation in the description and/or in the drawing.

Relative terms such as left, right, up, and down are for convenience only and are not intended to be limiting.

### BRIEF DESCRIPTION OF THE DRAWINGS

FIG. 1 is a schematic representation of a first embodiment of a device according to the invention;

FIG. 2 is a view in a similar representation as in FIG. 1 of a second embodiment of a device according to the invention;

FIG. 3 is a view in the same representation as in FIG. 1 of a third embodiment of a device according to the invention; and

FIG. 4 is a view in the same representation as in FIG. 1 of a fourth embodiment of a device according to the invention.

### DETAILED DESCRIPTION OF THE DRAWINGS

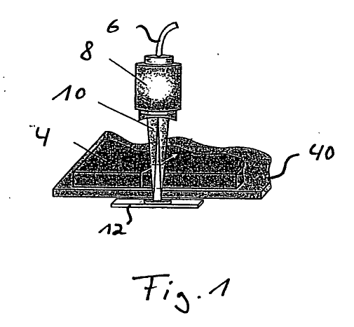

Shown in FIG. 1 is a device 2 according to the invention for the reparative machining of a component 4 made of glass; i.e., a flat glass pane in the present embodiment, which utilizes the generation of a thermally induced stress fracture, and which includes a machining head 8 that receives via an optical fiber 6 a laser-generated laser beam, for example emitted by an Nd:YAG laser (not shown).

Machining head 8 directs a laser beam 10 which exits optical fiber 6 and which forms an substantially point-shaped beam spot on a separation zone taking the form of a separating line on component 4 that is to be separatively machined, and along this separating line component 4 heats up, and is to be separatively machined upon cool-down by utilizing the thus generated thermal stress fracture of the component for machining. Moreover, device 2 includes a reflector 12 that is arranged underneath component 4.

A mounting device is provided according to the invention including a bearing surface 40 onto which component for machining 4 can be two-dimensionally mounted, and whereby the component 4 can be mounted while being supported in its entire area along its total expanse on the plane of the mounting area in order to reduce or prevent externally induced mechanical stresses, and whereby the bearing surface in this embodiment is completely comprised of a material that is highly transmissive for the laser beam. Correspondingly, the material of the bearing surface transmits laser beam 10, in particular in such a way that the beam impinges on reflector 12 which in turn reflects the laser beam back to the separation zone of component 4, and whereby the material of bearing surface 40 retransmits the laser beam.

Even though component for separative machining 4 substantially transmits the laser beam while only partially absorbing it, due to the reflection of the laser beam by reflector 12, a sufficient heating-up of component 4 for generating a thermally induced stress fracture is made possible in that the laser beam traverses component 4 at least twice, and during which process the material of component 4 partially absorbs the laser beam each time.

A device (not shown) is provided for heating up component 4 in a line-shaped fashion along the separating line that moves machining head 8 during the machining process in correspondence with the course of the separating line relative to component 4. To this end, reflector 12 can be moved together with machining head 8. If reflector 12 has a sufficiently large reflecting area in order to reflect the laser beam along the separating line during the entire movement of machining head 8 relative to component 4, it is also possible, however, to arrange reflector 12 in a stationary fashion.

When component 4 cools down, a thermally induced stress fracture is formed along the separating line whereby component 4 is separatively machined in the desired manner along the separating line.

Due to the fact that component 4 is mounted during the machining process on bearing surface 40, externally induced mechanical stresses that may have an undesirable influence on the machining process are avoided or reduced to a level that will no longer have any noteworthy consequences for the machining result.

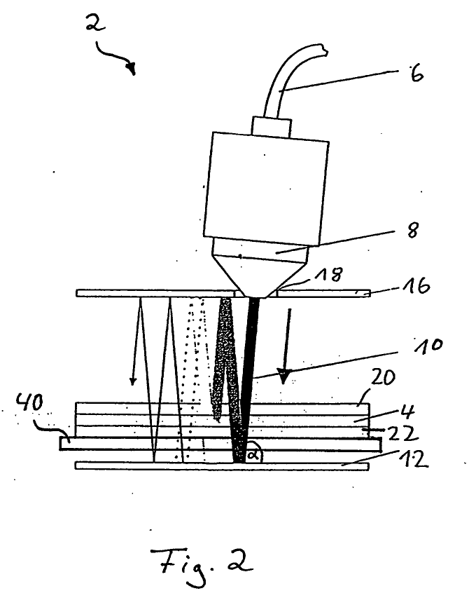

FIG. 2 represents a second embodiment of a device 2 according to the invention that differs from the embodiment in accordance with FIG. 1 primarily in that the reflecting device includes a second reflector 16 that is arranged on the side of flat glass pane 4 that is directed toward machining head 8; and first reflector 12 reflects the laser beam emitted by the laser device following its transmission through flat glass pane 4 onto second reflector 16, and whereby second reflector 16 reflects the beam that was reflected through first reflector 12 back to the separating line, as can be seen in FIG. 2, causing the laser beam to be reflected back and forth multiple times between reflectors 12, 16. For that purpose an opening 18 is provided in second reflector 16 through which machining head 8 directs the laser beam onto flat glass pane 4 at an acute angle of entry a that is smaller than 90 degrees.

In addition to flat glass pane 4, in accordance with the embodiment of FIG. 2, additional flat glass panes are machined simultaneously; FIG. 2 depicts only two further flat glass panes, identified by reference symbols 20, 22, that are stacked up on bearing surface 40. As a variation to the embodiment according to FIG. 2, it is possible to arrange two or multiple flat glass panes 20, 22 between bearing surface 40 and a counter-bearing surface, whereby both of the surfaces include a material that is highly transmissive for a laser beam.

Due to the fact that the angle of entry of the laser beam onto reflector 12 is not a right angle, the beam that is reflected from first reflector 12 impinges on a point on flat glass panes 4, 20, 22 that is at a minimal distance relative to a point along the separating line where beam 10 that is emitted by the laser impinges onto the separating line. Correspondingly, the beam that is reflected back and forth between first reflector 12 and second reflector 16 impinges, successively, on points that are at minimal distances relative to each other along the separating line on flat glass panes 4, 20, and 22. The distance is selected in such a way that flat glass panes 4, 20, 22 heat up sufficiently along the separating line, so that during the subsequent cool-down a thermally induced stress fracture forms along the separating line. If flat glass panes 20, 22 are arranged between bearing support 40 and a counter-bearing support, the laser beam traverses both the bearing surface as well as the counter-bearing surface.

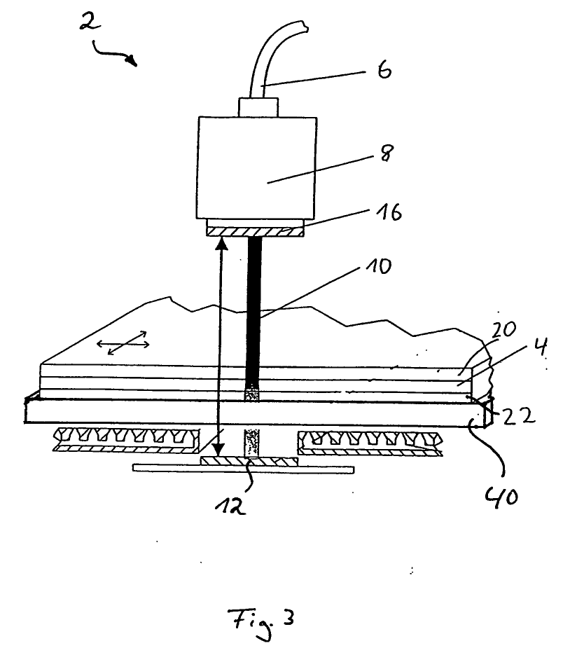

FIG. 3 shows a third embodiment of a device 2 according to the invention that differs from the embodiment according to FIG. 1 in that second reflector 16 includes a mirror that, depending on the polarization of the laser beam, either transmits or reflects the laser beam. First reflector 12 is configured in such a way that it changes the polarization direction of the laser beam upon it being reflected. The polarization of the laser beam that is emitted by the laser device is selected in such a way that the laser beam first transmits second reflector 16. With the subsequent reflection on first reflector 12, the polarization of the laser light is influenced in such a way that the laser light is reflected when it subsequently impinges upon second reflector 16. Following this, the laser light is reflected back and forth between first reflector 12 and second reflector 16 multiple times. This way it is possible to achieve a quick and intensive heating-up of flat glass panes 4, 20, and 22 at the irradiated point even though the latter substantially transmit the laser beam. In this context, bearing surface 40, which is highly transmissive for the laser beam, does not impede the passage of the laser beam. If flat glass panes 4, 20, 22 are, in accordance with a variation of the embodiment of FIG. 3, arranged between bearing surface 40 and a counter-bearing surface, the laser beam traverses both the bearing surface as well as the counter-bearing surface.

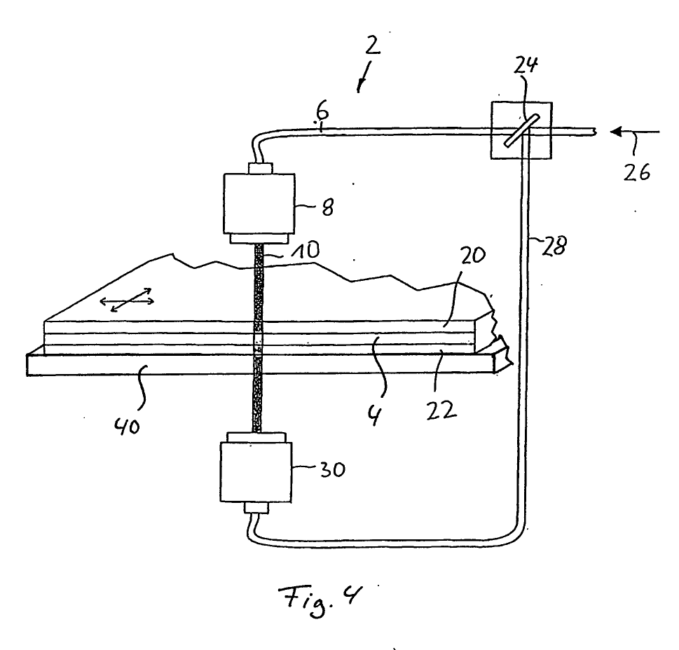

FIG. 4 depicts a fourth embodiment of a device 2 according to the invention having a beam splitting device in the form of a partially transmissive mirror 24 for splitting the laser beam that impinges on the mirror coming from the direction of an arrow 26. Mirror 24 divides the laser beam into two partial beams, whereby one partial beam is directed to machining head 8 via optic fiber 6 with this machining head directing this partial beam substantially at a right angle at components 4, 20, 22. The other partial beam is directed to another machining head 30 via optic fiber 28 with this machining head directing this partial beam substantially at a right angle at components 4, 20, 22, in particular substantially at the same point along the separation line at which machining head 8 directs the other partial beam, specifically in such a way that the two partial beams substantially coincide. In this process the laser beam is not impeded by bearing surface 40 during its passage through it because the bearing surface includes a material that is highly transmissive for the laser beam. Thus it is ensured that the laser beam traverses components 4, 20, 22 twice at the same point along the separation line allowing for the intensive heating-up of components 4, 20, 22 at that point. If, in accordance with a variation to the embodiment according to FIG. 4, components 4, 20, 22 are arranged between the bearing surface and a counter-bearing surface, laser beam 10 traverses both the bearing surface as well as the counter-bearing surface.

Instead of dividing the laser beam of a laser device by the use of a beam splitting device there exists also the option of using two separate lasers.

For the separative machining of a component it is necessary to generate an initial fracture. To this end, it may be required that a multiple-layer component to be machined that includes a plurality of material layers; these layers of material can be connected with each other, or they can be loose multiple layers of several plate-like flat glass panes.

A separation of only one of these material layers or flat glass panes of the multiple-layer component that is to be separated is possible if only the material layer or flat glass pane of the component that is to be separated receives an initial fracture, and whereby the material layer or flat glass pane is separated by way of the subsequent separative machining processes, while the other material layers or flat glass panes are not separated, even though the material layers or flat glass panes have the same physical properties (heat expansion coefficient, absorption behavior).

Thus it is possible to conduct the machining of both loosely piled flat glass panes as well as multiple-layer components with a plurality of material layers that are connected to each other in that the separation of only one material layer or of only one flat glass pane is effected.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Device for separative machining of a component made from brittle material by generation of a thermally induced stress fracture on the component in a separation zone, comprising:
a) a laser device provided for directing a laser beam onto the component for separative machining, in use, the component partially transmitting the laser beam, in use, at least twice and with partial absorption of the laser beam, and one of simultaneously and serially along the separation zone, and substantially at one of the same point and at points at minimal distances relative to each other;
b) a mounting device being provided, the mounting device including a bearing surface upon which the component made from brittle material for machining can be mounted, in use, in order to substantially avoid externally induced mechanical stresses on the component, in use; and
c) the bearing surface including at least in part a material that is highly transmissive for the laser beam, in use.

2. Device for separative machining of a component made from brittle material by generation of a thermally induced stress fracture on the component in a separation zone, comprising:
a) a laser device provided for directing a laser beam onto the component for separative machining, in use, the component partially transmitting the laser beam, in use, at least twice and with partial absorption of the laser beam, and one of simultaneously and serially along the separation zone, and substantially at one of the same point and at points at minimal distances relative to each other;
b) a mounting device being provided, the mounting device including a bearing surface upon which the component made from brittle material for machining can be mounted, in use, in order to substantially avoid externally induced mechanical stresses on the component, in use; and
c) the bearing surface including at least in part a material that is reflective for the laser beam.

3. Device as claimed in claim 2, wherein:
a) the mounting device includes a counter-bearing surface, and a multitude of components for machining can be received one of:
i) stacked one on top of the other between the bearing surface and the counter-bearing surface; and
ii) arranged one next to the other between the bearing surface and the counter-bearing surface; and
b) the counter-bearing surface includes a material that is highly transmissive for the laser beam.

4. Device as claimed in claim 2, wherein:
a) one of the bearing surface and the counter-bearing surface is configured substantially as flat for the mounting of a component that is substantially flat at least on one side, in use.

5. Device as claimed in claim 2, wherein:
a) the material has one of a lower thermal expansion coefficient and a higher transmissivity for the laser beam than the material of the component for machining.

6. Device as claimed in claim 2, wherein:
a) the material that is reflective for the laser beam is part of a reflecting device having a first reflector on the side of the component, in use, that is directed away from the laser device, and that reflects the laser beam transmitted through the component onto the separation zone, in use.

7. Device as claimed in claim 6, wherein:
a) the reflecting device includes at least in part a region of the bearing surface that reflects the laser beam.

8. Device as claimed in claim 2, wherein:
a) the bearing surface is at least in part provided with a coating that reflects the laser beam.

9. Device as claimed in claim 2, wherein:
a) a mounting element is provided that is made up of layers with at least one mounting layer that has formed on it the bearing surface made from a material that is highly transmissive for the laser beam, and with a reflecting layer that is made from of a material that reflects the laser beam.

10. Device as claimed in claim 6, wherein:
a) the reflecting device includes at least a second reflector arranged on the side of component, in use, that is directed toward the laser device; and
b) the first reflector, in use, reflects the laser beam through the separation zone onto the second reflector, and the second reflector reflects the laser beam from the first reflector onto the separation zone.

11. Device as claimed in claim 6, wherein:
a) the reflecting device is configured as one of flat and curved.

12. Device as claimed in claim 10, wherein:
a) the second reflector reflects the laser beam back onto first reflector.

13. Device as claimed in claim 12, wherein:
a) the incoming laser beam and the laser beam reflected by one of the first reflector and the laser beam that is reflected by the first reflector onto the second reflector and the laser beam that is reflected back from the second reflector onto the first reflector impinge substantially at the same point on the component along the separation zone, in use.

14. Device as claimed in claim 12, wherein:
a) the first reflector and, if need be, the second reflector are arranged at a distance relative to each other in the direction of the beam relative to the component for machining.

15. Device as claimed in claim 2, wherein:
a) the laser device includes at least two lasers that respectively direct one laser beam along the separation zone of the component, in use, substantially to one of a same point and points arranged at a minimal distance relative to each other on the component, in use.

16. Device as claimed in claim 15, wherein:
a) the at least two lasers are arranged on opposite sides of the component, in use.

17. Device as claimed in claim 2, wherein:
a) a beam splitting device that divides the laser beam of the laser device at least into two partial beams is provided; and
b) a beam directing device is provided that directs the two partial beams along the separation zone, in use, and substantially to the one of the same point and points that are arranged at a minimal distance relative to each other on component, in use.

18. Device as claimed in claim 2, wherein:
a) the beam directing device directs the partial beams from opposing sides onto the component, in use.

19. Device as claimed in claim 2, wherein:
a) the laser device includes one of an Nd:YAG laser, a Yb:YAG laser, and a diode laser.

20. Device as claimed in claim 2, wherein:
a) the wavelength of the laser beam is approximately 500 to approximately 5,300 nm, in particular 1,000 nm.

21. Device as claimed in claim 2, wherein:
a) the component, in use, is a flat glass plane.

22. Device as claimed in claim 2, wherein:
a) the component, in use, includes at least two components; and
b) for the purpose of the simultaneous machining of the at least two components, these components are serially arranged in the direction of the laser beam, in use.

23. Device as claimed in claim 22, wherein:
a) the at least two components include flat glass panes arranged resting against each other, in use.

24. Device as claimed in claim 22, wherein:
a) at least one spacer device is arranged between the at least two components including at least sectionally a material that is highly transmissive for the laser beam.

25. Device as claimed in claim 24, wherein:
a) the spacer device is one of coated with a friction-reducing element and a friction-reducing element is arranged between the component for machining and the bearing surface, in use.

26. Device as claimed in claim 25, wherein:
a) the friction-reducing element is arranged outside of the path of the laser beam.

27. Device as claimed in claim 2, wherein:
a) the component, in use, includes one of borosilicate glass and soda-lime glass.

28. Device as claimed in claim 2, wherein:
a) a device is provided for moving the component and the laser device, in use, relative to each other.

29. Device as claimed in claim 2, wherein:
a) a second reflector is provided and configured in such a way that, depending on the polarization of the laser beam, the second reflector one of transmits and reflects the laser beam, in use; and
b) the laser supplies the laser beam from the side that is directed away from first reflector;
c) the polarization of the laser beam is selected so that the second reflector transmits the incoming laser beam; and
d) the first reflector influences the polarization of the laser beam in such a way that the second reflector reflects the laser beam of a subsequent impingement of the laser beam, in use.

30. Device as claimed in claim 2, wherein:
a) a device is provided for shaping the laser beam.

31. Device as claimed in claim 2, wherein:
a) a measuring device is provided for the measurement of one of a temperature distribution, a stress distribution in the component for machining; and
b) one of a control device and a regulation device to one of control and to regulate the output and the intensity and the focus and the beam profile of the laser beam in correlation with at least one output signal of the measuring device, in use.

32. Device as claimed in claim 1, wherein:
a) the mounting device includes a counter-bearing surface, and a multitude of components for machining can be received one of:
i) stacked one on top of the other between the bearing surface and the counter-bearing surface; and
ii) arranged one next to the other between the bearing surface and the counter-bearing surface; and
b) the counter-bearing surface includes a material that is highly transmissive for the laser beam.

33. Device as claimed in claim 1, wherein:
a) one of the bearing surface and the counter-bearing surface is configured substantially as flat for the mounting of a component that is substantially flat at least on one side, in use.

34. Device as claimed in claim 1, wherein:
a) the material has one of a lower thermal expansion coefficient and a higher transmissivity for the laser beam than the material of the component for machining.

35. Device as claimed in claim 1, wherein:
a) the bearing surface includes at least in part a material that is reflective for the laser beam.

36. Device as claimed in claim 35, wherein:
a) the material that is reflective for the laser beam is part of a reflecting device having a first reflector on the side of the component, in use, that is directed away from the laser device, and that reflects the laser beam transmitted through the component onto the separation zone, in use.

37. Device as claimed in claim 36, wherein:
a) the reflecting device includes at least in part a region of the bearing surface that reflects the laser beam.
